(19) United States
(12) Patent Application Publication
(10) Pub. No.: US 2016/0039688 A1
(43) Pub. Date: Feb. 11, 2016

(54) WATER RECLAMATION SYSTEM AND DEIONIZATION TREATMENT DEVICE, AND WATER RECLAMATION METHOD

(71) Applicants: MITSUBISHI HEAVY INDUSTRIES MECHATRONICS SYSTEMS, LTD., Kobe-shi (JP); MITSUBISHI HEAVY INDUSTRIES, LTD., Tokyo (JP)

(72) Inventors: Hideo SUZUKI, Tokyo (JP); Hiroshi NAKASHOJI, Tokyo (JP); Kazuhide KAMIMURA, Hyogo (JP); Hozumi OTOZAI, Hyogo (JP); Takeshi TERAZAKI, Hyogo (JP)

(21) Appl. No.: 14/779,562

(22) PCT Filed: Mar. 29, 2013
(86) PCT No.: PCT/JP2013/059496

§ 371 Date: Sep. 23, 2015

(51) Int. Cl. C02F 1/469; C02F 5/00

(52) U.S. Cl. CPC C02F 1/4691; C02F 5/00; C02F 1/4695; C02F 2303/22; C02F 2201/46

(57) ABSTRACT

An object of the invention is to reliably prevent the precipitation of scale during a reclamation step in a deionization treatment. A water reclamation system and a deionization treatment device of the present invention each comprises a deionization section, a supply section which supplies a scale inhibitor to a water to be treated, and a control section. The control section acquires a supply start time and a supply stop time for at least one of the scale inhibitor and a low ion concentration water based on the concentration of a scale component in the deionization section, and causes the supply section to supply at least one of the scale inhibitor and the low ion concentration water in the interval between the supply start time and the supply stop time.

### RELATED APPLICATIONS

The present application is a National Phase of International Application Number PCT/JP2013/059496, filed Mar. 29, 2013.

### TECHNICAL FIELD

The present invention relates to a water reclamation system and a deionization treatment device, and to a water reclamation method.

### BACKGROUND ART

Industrial waste water discharged from a plant is subjected to cleaning treatments such as the removal of heavy metal components and suspended particles, and the decomposition and removal of organic matter. In locations where a supply of industrial water is difficult to secure, process water that has been subjected to a cleaning treatment is reused as industrial water. In this case, after removing heavy metal components, suspended particles, and organic matter and the like, a deionization treatment is performed in which the ion components included in the waste water are removed.

Furthermore, when using river water or ground water, in those situations where a high salt content is detrimental, a deionization treatment is performed in which the ion components included in the water are removed.

Examples of known deionization treatment devices include reverse osmosis membrane deionization devices and deionization treatment devices (for example, see PTL 1).

A reverse osmosis membrane deionization device comprises a reverse osmosis membrane (RO membrane) as an internal component. When water containing ions flows into the reverse osmosis membrane deionization device, the reverse osmosis membrane allows only water to pass through the membrane. The water (treated water) that has passed through the reverse osmosis membrane is reused as industrial water or the like. The water on the upstream side of the reverse osmosis membrane is a concentrated water in which the ions that could not pass through the reverse osmosis membrane have been concentrated. By discharging this concentrated water from the reverse osmosis membrane deionization device, the concentrated water is discharged to the outside of the water treatment system. When the ratio of treated water to supplied water is high, the scale component which includes the scale component ions in the concentrated water exceeds the saturation solubility, causing a scale to form.

In a deionization treatment device described in PTL 1, first, a pair of electrodes are charged with voltages of opposite polarities. When the water to be treated flows between the electrodes in this state, the ion components adsorb to the electrodes (deionization step). As a result of this deionization step, treated water is recovered. Once the ion adsorption performance of the electrodes has approached a saturate state, if the electrodes are shorted or the opposite voltage from that used for ion adsorption is applied, then the adsorbed ion components desorb from the electrodes. Concurrently with the desorption of the ion components, or following the desorption, the liquid to be treated or a liquid with a lower ion concentration than the liquid to be treated is passed between the electrodes, thereby removing the ions from between the electrodes and discharging the ion components as a concentrated water (reclamation step). Thereafter, the deionization step and the reclamation step are repeated.

The salt content of a water to be treated (such as a waste water, river water or ground water) includes calcium carbonate (CaCO₃), calcium sulfate (CaSO₄), calcium fluoride (CaF₂), and silica (SiO₂). When the saturation solubility is exceeded, these substances precipitate as a crystalline solid fraction (scale). For example, in the case of calcium carbonate, if the water contains 275 mg/l at a pH of 7.3, then a scale precipitates because the saturation solubility has been exceeded. However, with this solution, the scale does not precipitate within 10 minutes of preparation, but does precipitate after one day.

In a reverse osmosis membrane deionization device, because the scale component is continuously removed by the membrane, operating at a high recovery ratio results in a constantly high ion concentration on the concentrated water side, and because the concentrated water remains at or above saturation solubility for a long time (a day or longer), a scale precipitates.

In a deionization treatment device, in the reclamation step, desorption of the ions from the electrodes results in the presence of a concentrated water between the electrodes. If the reclamation step lasts no longer than 10 minutes, then the deionization step begins before scale precipitation occurs. Because the start of the deionization step prevents the scale component concentration in the water between the electrodes from reaching saturation solubility, scale precipitation is prevented. By utilizing this property, a deionization treatment device of the type disclosed in PTL 1 is advantageous in terms of yielding a higher recovery ratio (the ratio of reusable water that can be recovered) than a reverse osmosis membrane deionization device.

### CITATION LIST

### Patent Literature

### {PTL 1}

Publication of Japanese Patent No. 4,090,635

### SUMMARY OF INVENTION

### Technical Problem

On the other hand, when the proportion of treated water (deionized water) is high relative to the volume of water supplied to the deionization treatment device, most of the ions will be included in the concentrated water during the reclamation step, giving the concentrated water a high ion concentration. If the ion concentration is such that the scale component exceeds the saturation solubility, then scale deposition will occur more quickly the higher the ion concentration becomes. For example, in an aqueous solution with a fluorine concentration of 18.5 mg/l and a calcium concentration of 675 mg/l at a pH of 6.2, scale does not precipitate after 10 minutes, but does precipitate after one day. However, in an aqueous solution with a fluorine concentration of 37 mg/l and a calcium concentration of 1350 mg/l at a pH of 6.2, scale precipitates within 10 minutes.

The precipitated scale blocks the internal flow channel (inter-electrode flow channel) of the deionization treatment device, preventing the water to be treated from flowing at the prescribed flow rate. For this reason, it is desirable to avoid precipitation of scale even when producing concentrated water with a high concentration of ions.

An object of the present invention is to provide a water reclamation system and deionization treatment device which can reliably prevent the occurrence of scale even when the ion concentration is high in the reclamation step, and a water reclamation method using this system and device.

### Solution to Problem

A first aspect of the present invention is a water reclamation system, comprising: a deionization section which comprises a pair of opposing electrodes that are charged with opposite polarities, an inter-electrode flow channel positioned between the electrodes and through which a water to be treated containing ions can flow, and ion exchange membranes disposed on the inter-electrode flow channel side of each of the electrodes, the deionization section performing a deionization treatment in which the ions are adsorbed to the electrodes and a reclamation treatment in which the ions are desorbed from the electrodes; a treated water discharge channel which is positioned downstream from the deionization section and discharges, from the deionization section, a treated water from which the ions have been removed during the deionization treatment; a concentrated water discharge channel which is positioned downstream from the deionization section and discharges, from the deionization section, a concentrated water which contains the ions desorbed from the electrodes during the reclamation treatment; a supply section which supplies, to the deionization section, at least one of a scale inhibitor and a low ion concentration water which has a lower concentration than the concentrated water of scale component ions which are the ions forming the scale component; and a control section which, based on the concentration of the scale component in the deionization section, acquires a supply start time at which the supply section supplies, to the deionization section, at least one of the scale inhibitor and the low ion concentration water, and a supply stop time at which the supply section stops supply of at least one of the scale inhibitor and the low ion concentration water, and which causes the supply section to supply at least one of the scale inhibitor and the low ion concentration water in an interval between the supply start time and the supply stop time.

A second aspect of the present invention is a deionization treatment device, comprising: a deionization section which comprises a pair of opposing electrodes that are charged with opposite polarities, an inter-electrode flow channel positioned between the electrodes and through which a water to be treated containing ions can flow, and ion exchange membranes disposed on the inter-electrode flow channel side of each of the electrodes, the deionization section performing a deionization treatment in which the ions are adsorbed to the electrodes and a reclamation treatment in which the ions are desorbed from the electrodes; a treated water discharge channel which is positioned downstream from the deionization section and discharges, from the deionization section, a treated water from which the ions have been removed during the deionization treatment; a concentrated water discharge channel which is positioned downstream from the deionization section and discharges, from the deionization section, a concentrated water which contains the ions desorbed from the electrodes during the reclamation treatment; a supply section which supplies, to the deionization section, at least one of a scale inhibitor and a low ion concentration water which has a lower concentration than the concentrated water of scale component ions which are the ions forming the scale component; and a control section which, based on the concentration of the scale component in the deionization section, acquires a supply start time at which the supply section supplies, to the deionization section, at least one of the scale inhibitor and the low ion concentration water, and a supply stop time at which the supply section stops supply of at least one of the scale inhibitor and the low ion concentration water, and which causes the supply section to supply at least one of the scale inhibitor and the low ion concentration water in an interval between the supply start time and the supply stop time.

A third aspect of the present invention is a water reclamation method performed in a deionization section which comprises a pair of opposing electrodes that are charged with opposite polarities, an inter-electrode flow channel positioned between the electrodes and through which a water to be treated containing ions can flow, and ion exchange membranes disposed on the inter-electrode flow channel side of each of the electrodes, the method comprising: a deionization step of adsorbing the ions in the water to be treated to the electrodes to produce a treated water; a reclamation step of desorbing the adsorbed ions from the electrodes and releasing the ions into the inter-electrode flow channel, and discharging a concentrated water containing the desorbed ions from the deionization section; and a supply step in which at least one of a scale inhibitor and a low ion concentration water which has a lower concentration than the concentrated water of scale component ions which are the ions forming the scale component is supplied to the deionization section, wherein the supply step comprises: an acquisition step of acquiring, based on the concentration of the scale component in the deionization section, a supply start time at which supply of at least one of the scale inhibitor and the low ion concentration water is started, and a supply stop time at which supply of at least one of the scale inhibitor and the low ion concentration water is stopped; a supply start step in which supply of at least one of the scale inhibitor and the low ion concentration water is started at the supply start time; and a supply stop step, performed following the supply start step, in which supply of at least one of the scale inhibitor and the low ion concentration water is stopped at the supply stop time.

As a result of the release into the inter-electrode flow channel of the ions adsorbed to the electrodes during reclamation treatment, the scale component concentration in the concentrated water increases. Furthermore, in circumstances such as when the amount of water supplied to the deionization section is less than a predetermined amount, or the amount of treated water has reached a prescribed value and there is no need to produce more, the deionization section stops without resuming deionization treatment. In such cases, a concentrated water having a scale component concentration that exceeds the saturation concentration is retained in the inter-electrode flow channel for a long time.

In the water reclamation system and the deionization treatment device of the present invention, the control section uses the scale component concentration in the concentrated water to acquire the supply start time and the supply stop time for the scale inhibitor and/or the low ion concentration water. Moreover, the scale inhibitor and/or the low ion concentration water is supplied from the supply section to the deionization section in the period between the supply start time and the supply stop time. In the water reclamation method of the present invention, the scale inhibitor and/or the low ion concentration water is supplied to the deionization section in the period between the supply start time and the supply stop time acquired in the acquisition step.

By employing this configuration, even if the concentration of the scale component in the inter-electrode flow channel exceeds the saturation concentration during the reclamation step or while the deionization section is stopped, the occurrence of scale can be reliably prevented. In addition, because the supply of the scale inhibitor and/or the low ion concentration water can be performed efficiently, operating costs can be reduced.

In the first or second aspect of the invention, the supply section may be installed upstream from the deionization section, and the control section can acquire the supply start time from the time at which the scale component concentration reaches a first threshold and the retention time, which represents the time the water to be treated is retained in the deionization section, and acquire the supply stop time from the time at which the scale component concentration reaches a second threshold that is at least 0.5 times and not more than 1 times the first threshold, and the retention time.

In the third aspect of the invention, in the acquisition step, the supply start time can be acquired from the time at which the scale component concentration reaches a first threshold and the retention time, which represents the time the water to be treated is retained in the deionization section, and the supply stop time can be acquired from the time at which the scale component concentration reaches a second threshold that is at least 0.5 times and not more than 1 times the first threshold, and the retention time.

In the aspects described above, the time the water is retained in the deionization section is considered when acquiring the time at which supply of at least one of the scale inhibitor and the low ion concentration water is started and stopped. Here, the first threshold is the saturation concentration value of the scale component, or a value higher than the saturation concentration value of the scale component.

In this manner, the supply of the scale inhibitor and/or the low ion concentration water can accurately reflect the scale component concentration in the deionization section.

In the first or second aspects, the supply section may be connected to the inter-electrode flow channel, and the control section can acquire the time at which the scale component concentration reaches a first threshold as the supply start time, and the time at which the scale component concentration reaches a second threshold that is at least 0.5 times and not more than 1 times the first threshold as the supply stop time.

In the third aspect, in the acquisition step, the time at which the concentration of the scale component in the water to be treated passing through the inter-electrode flow channel reaches a first threshold can be acquired as the supply start time, and the time at which the concentration of the scale component in the water to be treated passing through the inter-electrode flow channel reaches a second threshold that is at least 0.5 times and not more than 1 times the first threshold can be acquired as the supply stop time.

If the scale inhibitor and/or the low ion concentration water is supplied directly to the deionization section in this manner, then the retention time and the like need not be considered. Accordingly, if the supply start time and the supply end time are determined from the concentration of the scale component in the deionization section as described in the configuration above, then the supply of the scale inhibitor and/or the low ion concentration water can accurately reflect the scale component concentration in the deionization section, allowing scale formation to be reliably prevented.

The first or second aspect may further comprise a circulation section which circulates at least one of the concentrated water discharged from the deionization section and the treated water to the supply section, and the control section may feed at least one of the concentrated water having a low concentration of the scale component ions and the treated water as the aforementioned low ion concentration water to the supply section through the circulation section, and supply the water from the supply section to the deionization section.

In the third aspect, in the supply step, at least one of the concentrated water having a low concentration of the scale component ions and the treated water may be supplied as the low ion concentration water.

At the beginning and end of the reclamation treatment, the residual ion concentration in the deionization section is low. For this reason, there is no concern that circulating the concentrated water from the beginning or end of the reclamation treatment into the deionization section as a low ion concentration water may cause the scale component concentration to exceed the saturation concentration and produce scale. Furthermore, because the treated water generated by the deionization step has a reduced ion concentration, it can be used as a low ion concentration water. By employing such a configuration, the amount of fresh water supplied from outside can be reduced, and water reclamation can be performed efficiently.

In the first or second aspect, the control section may control the flow rate of the low ion concentration water based on the concentration of the scale component in the deionization section.

In the third aspect, in the supply step, the flow rate of the low ion concentration water may be controlled so that the concentration of the scale component in the deionization section is not more than the first threshold.

In this manner, by changing the flow rate of the low ion concentration water based on the scale component concentration in the deionization section, there is no need to supply more than the required amount of the low ion concentration water, allowing low ion concentration water usage to be suppressed. In particular, when using the treated water as the low ion concentration water, any reduction in the recovery ratio can be suppressed.

In the first or second aspect, a measurement section which measures the concentration of the scale component ions may be installed downstream from the deionization section or connected to the inter-electrode flow channel, wherein the measurement section measures the concentration of the scale component ions, and the control section acquires the concentration of the scale component from the concentration of scale component ions measured by the measurement section, and acquires the supply start time and the supply stop time based on the scale component concentration.

The method of the third aspect may further comprise a measurement step in which the concentration of the scale component ions in the concentrated water that has passed through the inter-electrode flow channel or the concentration of the scale component ions in the water to be treated passing through the inter-electrode flow channel is measured, and in the acquisition step, the concentration of the scale component may be acquired from the measured concentration of the scale component ions, and the supply start time and supply stop time may be acquired based on the scale component concentration.

In this manner, by employing a configuration in which the supply start time and the supply stop time are acquired using a scale component concentration acquired from the concentration of scale component ions measured by the measurement section, when the water quality of the water to be treated is variable, the amount of scale inhibitor or low ion concentration water supplied can be changed in accordance with the water quality, or a choice can be made to supply no scale inhibitor or low ion concentration water if none is required. In other words, the supply of the scale inhibitor and/or the low ion concentration water can be made more efficient.

Furthermore, by connecting a measurement section to the inter-electrode flow channel between the electrodes and measuring the ion concentration of the water to be treated flowing between the electrodes, the amount of the scale inhibitor and/or the low ion concentration water supplied can be managed more precisely.

### Advantageous Effects of Invention

In the present invention, because the supply of the scale inhibitor and/or the low ion concentration water is controlled based on the concentration of the scale component in the deionization section, scale precipitation can be reliably prevented. Furthermore, there is no need to supply an excess amount of the scale inhibitor and/or the low ion concentration water, allowing water reclamation to be performed efficiently.

### BRIEF DESCRIPTION OF DRAWINGS

FIG. 1 A block diagram of a water reclamation system.

FIG. 2 A schematic diagram of a deionization section.

FIG. 3 A schematic diagram of a deionization treatment device according to a first embodiment.

FIG. 4 An example of a timing chart explaining an operation method for the deionization treatment device according to the first embodiment.

FIG. 5 An alternative example of a timing chart explaining an operation method for the deionization treatment device according to the first embodiment.

FIG. 6 A schematic diagram of a deionization treatment device according to a second embodiment.

FIG. 7 A schematic diagram of a deionization treatment device according to a fourth embodiment.

### DESCRIPTION OF EMBODIMENTS

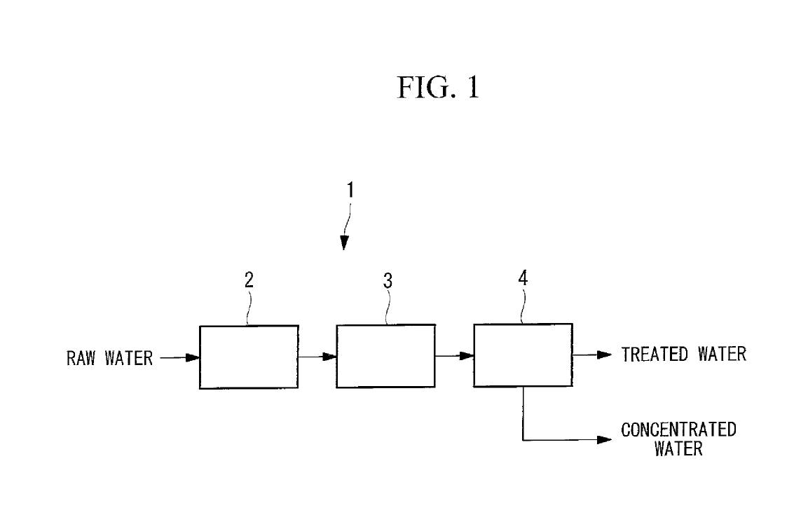

FIG. 1 shows one example of a block diagram of a water reclamation system. A water reclamation system 1 comprises, from the upstream side, a pretreatment section 2, an organic matter treatment section 3, and a deionization treatment device 4.

The pretreatment section 2 takes in a water to be treated such as river water or waste water from a plant, and removes oils, heavy metals, and suspended particles and the like from the water to be treated. If the water to be treated contains only small amounts of such matter, the pretreatment section 2 may be omitted.

The organic matter treatment section 3 subjects the organic matter in the water treated by the pretreatment section 2 to a decomposition treatment. The organic matter treatment section 3 has a configuration that includes an appropriate combination of a biological treatment section that uses microorganisms to decompose and remove organic matter, a chemical oxidation treatment section that performs oxidation treatment of the organic matter by chemical means, activated carbon, and an ultraviolet treatment device.

Examples of the biological treatment section include a membrane bio-reactor (MBR) and a bio-film reactor (BFR).

In an MBR, a membrane with a pore size of approximately 0.1 μm is immersed in the supply water in a bioreaction vessel. Microorganisms are present in the supply water in the bioreaction vessel, and those microorganisms decompose the organic matter in the supply water. Microorganisms that are useful for sludge treatment in the bioreaction vessel are no smaller than about 0.25 μm. Accordingly, the supply water in the bioreaction vessel is subjected to a liquid-solid separation into supply water and microorganisms by the membrane, and only the supply water is discharged from the MBR.

In a BFR, a support structure having a film of microorganisms formed on the surface is provided inside the reactor. When the microorganisms on the surface of the support structure contact the supply water, the microorganisms decompose the organic matter in the supply water.

In the case of a configuration that combines an MBR and a BFR, the operations of the MBR and BFR are controlled in accordance with the amount of organic matter (COD) in the supply water. For example, if the COD within the supply water is low, only the MBR might operate. When a large variation in COD is observed, the BFR might operate in parallel with the MBR.

If the water to be treated contains only a small amount of organic matter, the biological treatment section can be omitted.

Examples of chemical oxidation treatments include methods in which hypochlorous acid or hydrogen peroxide is supplied to the water to be treated, and methods in which the water to be treated is subjected to ozone irradiation.

### First Embodiment

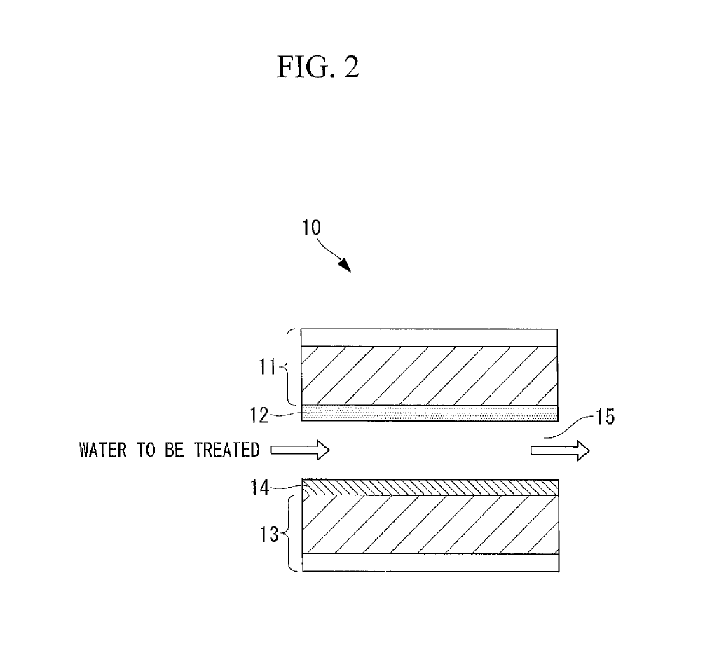

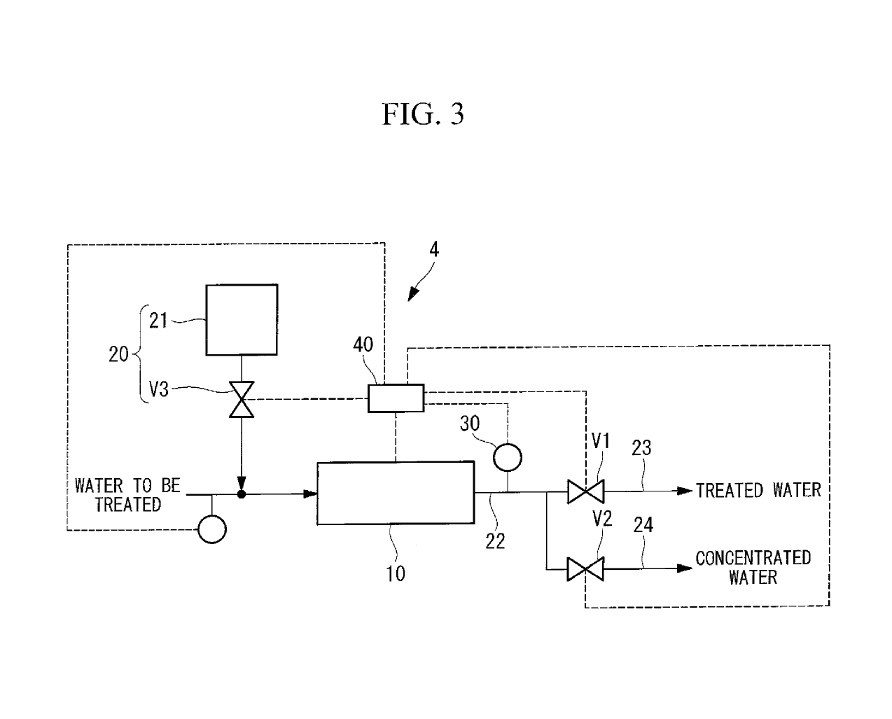

FIG. 2 and FIG. 3 are schematic diagrams of the deionization treatment device 4. The deionization treatment device 4 comprises a deionization section 10, a supply section 20, and a control section 40. In the water reclamation system in FIG. 1, a configuration may be employed in which a plurality of deionization treatment devices 4 are connected in series, in parallel, or in a combination of series and arrays.

As illustrated in FIG. 2, the deionization section 10 comprises a pair of opposing porous electrodes 11 and 13, and an inter-electrode flow channel 15 through which supply water can flow between the electrodes. An anion exchange membrane 12 is provided on the inter-electrode flow channel side of the electrode 11, and a cation exchange membrane 14 is provided on the inter-electrode flow channel side of the electrode 13.

As illustrated in FIG. 3, a discharge channel 22 is provided on the downstream side of the deionization section 10. The discharge channel 22 branches, partway along the channel, into a treated water discharge channel 23 and a concentrated water discharge channel 24. Valves V1 and V2 are provided in the treated water discharge channel 23 and the concentrated water discharge channel 24 respectively.

In FIG. 3, on the upstream side of the deionization section 10, the supply section 20 is connected to piping through which the water to be treated flows. From the perspective of reducing the supplied amount of the scale inhibitor or low ion concentration water, the position at which the supply section 20 connects to the piping is preferably near the deionization section 10.

The supply section 20 comprises a tank 21 and a valve V3. The supply section 20 may also have a configuration in which a pump is provided instead of the valve, or a configuration that uses both a pump and a valve.

The tank 21 holds the scale inhibitor or low ion concentration water. Although FIG. 3 shows an example in which only one supply section 20 is provided, if both a scale inhibitor and a low ion concentration water are to be supplied, then two supply section 20 are provided with each tank 21 separately holding one or other of the scale inhibitor and the low ion concentration water.

For the scale inhibitor, a chelate scale inhibitor or a phosphonate scale inhibitor may be used (for example PC191 manufactured by Ondeo Nalco Company, or Kimic SI manufactured by Kimic Chemitech(s) Pte., Ltd.).

Low ion concentration water is a water in which the concentration of ions that form the scale component (scale component ions) is lower than in the concentrated water. Scale component ions include metal ions such as alkaline earth metal ions and Mg²⁺, and anions such as SO₄²⁻, CO₃²⁻ and F⁻. These ions form salts which have poor solubility in water. Silica ions are also scale component ions. In the present embodiment, the low ion concentration water is, for example, an ion exchanged water or a water that has been passed through a reverse osmosis membrane deionization device.

FIG. 3 shows an example in which a measurement section 30 is provided in the discharge channel 22. The measurement section 30 measures the concentration of ions contained in the water discharged from the deionization section 10. The measurement section 30 need not necessarily be permanently installed in the deionization treatment device 4 during the treatment process.

The water to be treated contains mainly Ca²⁺ and silica ions as scale component ions. Accordingly, the ions to be measured in this case are calcium ions (Ca²⁺) and silica ions. Thus, the measurement section 30 is a concentration meter that measures the Ca²⁺ and silica ions and the like in the water to be treated. In this case, in addition to the ions mentioned above, SO₄²⁻, CO₃²⁻ and F⁻ which bond with Ca²⁺ may also be measured.

Alternatively, an electrical conductivity meter may be provided as the measurement section 30 and used to acquire the electrical conductivity of the water discharged from the deionization section 10.

Furthermore, the saturation concentration of the water to be treated varies depending on the pH. Accordingly, by installing a pH meter as the measurement section 30, the saturation concentration of the scale component can be estimated from the pH of the water discharged from the deionization section 10, and used to acquire the times at which to start and stop supply of the scale inhibitor and/or the low ion concentration water.

The control section 40 is, for example, a computer. The control section 40 is connected to the deionization section 10, the measurement section 30, and the valves V1 to V3.

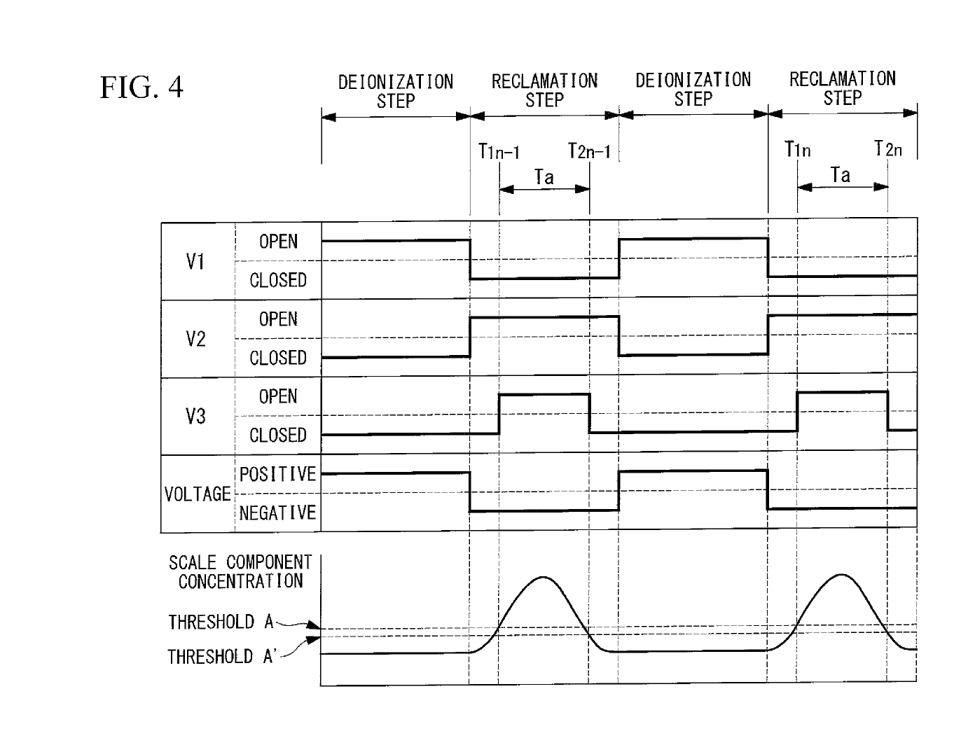

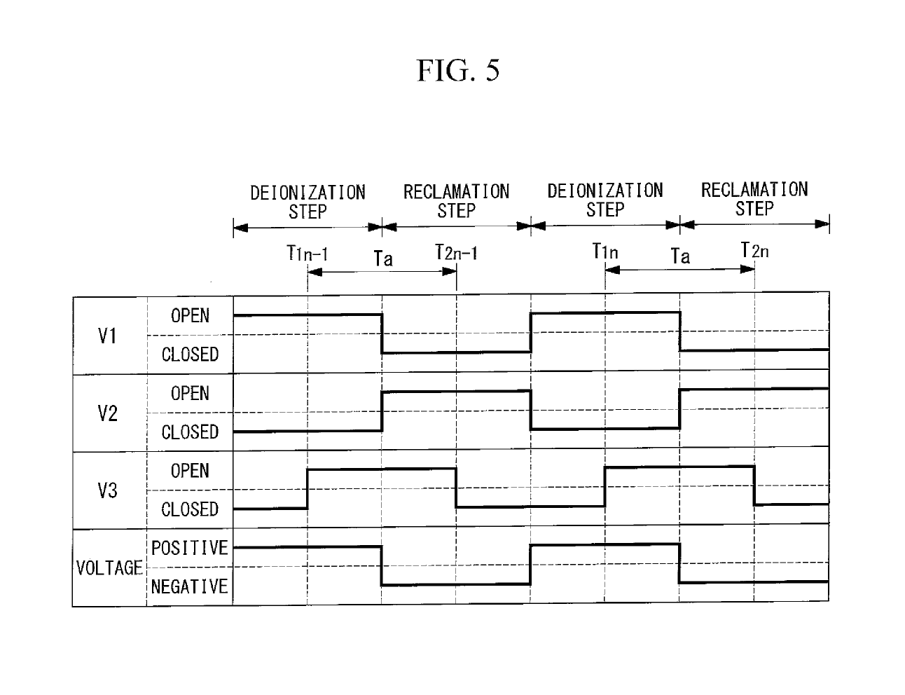

A water reclamation method of the first embodiment is described below. FIG. 4 and FIG. 5 are timing charts explaining the operation method for the deionization treatment device. The “scale component concentration” part of FIG. 4 schematically illustrates the concentration of the scale component in the inter-electrode flow channel of the deionization section 10.

### (Deionization Step)

The control section 40 applies a voltage to the electrodes 11 and 13 so that the electrode 11 adopts a positive polarity and the electrode 13 adopts a negative polarity. In FIG. 4 and FIG. 5, this energized state is indicated as “positive”. The control section 40 opens the valve V1 and closes the valves V2 and V3.

The water to be treated containing ions flows into the deionization section 10 having the electrodes 11 and 13 in an energized state. When the water to be treated flows through the inter-electrode flow channel 15 between the electrodes 11 and 13, the negative ions in the water to be treated pass through the anion exchange membrane 12 and adsorb to the electrode 11, and the positive ions pass through the cation exchange membrane 14 and adsorb to the electrode 13. As a result, the ions are removed from the water to be treated.

The water to be treated with the ions removed is then discharged from the deionization section 10 as a treated water, passes through the treated water discharge channel 23, and is discharged outside the deionization treatment device to be recovered.

### (Reclamation Step)

After the deionization step has been performed for a predetermined time, the control section 40 applies a voltage to the electrodes 11 and 13 so that the electrode 11 adopts a negative polarity and the electrode 13 adopts a positive polarity. In other words, the energized state of the electrodes is reversed. At the same time as reversing the energized state of the electrodes 11 and 13, the control section 40 also closes the valve V1 and opens the valve V2. This begins the reclamation step.

In the reclamation step, the ions adsorbed in the deionization step are desorbed from the electrodes 11 and 13, and released into the inter-electrode flow channel 15. The released ions are discharged from the deionization section 10 by passing a liquid through the inter-electrode flow channel 15 during a supply step described below.

At the conclusion of the reclamation step, a water such as pure water or treated water with a low ion concentration is supplied and then discharged from the deionization section 10 together with the ions released into the inter-electrode flow channel 15. As a result of this reclamation step, the quantity of ions remaining on the electrodes 11 and 13 and in the inter-electrode flow channel 15 is greatly reduced. The water discharged from the deionization section 10 passes through the concentrated water discharge channel 24 as a concentrated water and is discharged outside the deionization treatment device 4.

The deionization step and the reclamation step are performed alternately each for a predetermined length of time. For example, the deionization step is performed for 1 to 10 minutes and the reclamation step for 1 to 5 minutes.

As illustrated in FIG. 4, the release of ions into the inter-electrode flow channel 15 in the reclamation step increases the ion concentration inside the deionization section 10 (inside the inter-electrode flow channel 15). When the concentration of the scale component in the deionization section 10 exceeds the saturation concentration, a state is obtained in which scale easily precipitates. Thus, in the present embodiment, when the scale component concentration in the deionization section 10 exceeds a predetermined value, a scale inhibitor or a low ion concentration water, or both a scale inhibitor and a low ion concentration water, are supplied to the deionization section 10.

Based on the concentration of the scale component, the control section 40 acquires the time period in which to supply the scale inhibitor and/or the low ion concentration water from the supply section 20. In the present embodiment, the time period in which to supply the scale inhibitor and/or the low ion concentration water may be acquired by permanently providing the measurement section 30 in the deionization treatment device 4 as illustrated in FIG. 4, using the measurement section 30 to acquire the concentration of scale component ions while performing the treatment, and acquiring the concentration of the scale component from the concentration of scale component ions. Alternatively, the measurement section 30 may be provided only during preliminary testing, test operation, or adjustment operation to acquire the time variation in the concentration of the scale component ions, and this concentration may then be used to acquire the variation in the concentration of the scale component, which is then used to acquire the time period in which to supply the scale inhibitor and/or the low ion concentration water.

First is a description of a method of acquiring the time period in which to supply the scale inhibitor and/or the low ion concentration water from the scale component ion concentration acquired by the measurement section 30 during treatment.

### (Measurement Step)

During the deionization step and the reclamation step, the measurement section 30 measures and acquires the concentration of ions that form the scale component in the water discharged from the deionization section 10. The measurement section 30 sends the acquired ion concentration to the control section 40.

### (Supply Step)

Next is a description of a supply step in which the scale inhibitor or the low ion concentration water, or both the scale inhibitor and the low ion concentration water, are supplied during operation of the deionization section 10.

The control section 40 uses the concentration of the scale component ions sent from the measurement section 30 to acquire the scale component concentration.

As described above, if the respective concentrations of cations such as Ca²⁺ and anions such as SO₄²⁻, CO₃²⁻ and F⁻ are measured, the scale component concentration can be acquired from the cation concentration and anion concentration.

Alternatively, the concentration of only the cations or only the anions may be measured, and the scale component concentration then acquired from the solubility product of the scale component. In this case, the ion concentration that varies the most is preferably is measured. For example, in the case of CaSO₄, the solubility product is K=[Ca]²[SO4]². The concentration of SO₄²⁻ is assumed to be constant. At this time, the concentration of SO₄²⁻ is preferably set to a high value. Using the Ca²⁺ concentration measured by the measurement section 30, the concentration of CaSO₄ relative to the saturation solubility is estimated from the solubility product, and the CaSO₄ concentration is acquired. The concentration of other scale components is acquired in a similar manner.

There is a positive correlation relationship between the electrical conductivity and the scale component concentration. The correlation between the electrical conductivity and the scale component concentration is acquired in advance and stored in the control section 40. The electrical conductivity values measured by the measurement section 30 are sent to the control section 40, and the control section 40 acquires the scale component concentration from the correlation relationship mentioned above.

The control section 40 stores a threshold A for the scale component concentration (first threshold). The threshold A is the saturation concentration of the scale component, or a value higher than the saturation concentration. Specifically, the threshold A is a value within a range of 1 to 1000 times the saturation concentration of the scale component, and is preferably a value within the range of 100 to 200 times the saturation concentration. When setting a value higher than the saturation concentration as the threshold A, the time taken scale precipitation to occur is identified in advance by testing, and a concentration is used for which the time until scale precipitation is sufficiently long.

In the (n−1)th (n≧2) deionization step and reclamation step, the control section 40 deems the time at which the (n−1)th deionization step begins to be 0, and acquires the time t1ₙ₋₁ at which the scale component concentration acquired from the measurements of the measurement section 30 reached the threshold A.

Because the measurement section 30 is installed downstream from the deionization section 10, the actual scale component concentration in the water to be treated inside the deionization section 10 is measured by the measurement section 30 after a delay equivalent to the length of time the water to be treated is retained in the deionization section 10. The retention time tr is expressed by formula (1).

tr=W/Q (1)
W: amount of water retained by deionization section (m³)
Q: flow rate of supplied water (m³/h)

In other words, the time at which the scale component concentration in the deionization section 10 reached the threshold A is t1ₙ₋₁−tr. The control section 40 acquires t1ₙ₋₁−tr and stores it in memory, as the supply start time T1ₙ at which V3 is opened in the nth deionization step and reclamation step.

In the (n−1)th (n≧2) deionization step and reclamation step, the control section 40 deems the time at which the (n−1)th deionization step began to be 0, and acquires the time t2ₙ₋₁ at which the scale component concentration acquired from the measurements of the measurement section 30 reached a threshold A′ (second threshold). The threshold A′ is a value within the range from 0.5 to 1 times the threshold A. Note that 1 times the threshold means A=A′. In this case, the control section 40 may monitor the variation over time in the scale component concentration, and apply threshold A if the concentration is increasing and threshold A′ if the concentration is decreasing.

In a similar manner, the time at which the scale component concentration in the deionization section 10 reached the threshold A′ is t2ₙ₋₁−tr. The control section 40 acquires the time t2ₙ₋₁−tr and stores it in memory, as the supply stop time T2ₙ at which V3 is closed in the nth deionization step and reclamation step.

As a result of this step, the control section 40 determines a period Ta, which is the time period between T1ₙ and T2ₙ during which the scale inhibitor and/or the low ion concentration water is supplied.

In the nth deionization step and reclamation step, the control section 40 opens the valve V3 at the acquired supply start time T1ₙ. The control section 40 closes the valve V3 at the acquired supply stop time T2ₙ. The timing chart of FIG. 4 shows an example in which the supply start time T1ₙ occurs during a reclamation step, with both the supply start time T1ₙ and the supply stop time T2ₙ occurring during the reclamation step. The timing chart in FIG. 5 shows an example in which the supply start time T1ₙ occurs in a deionization step and the supply stop time T2ₙ occurs in a reclamation step.

In the nth deionization step and reclamation step, the control section 40 opens and closes the valve V3, and also acquires the supply start time T1ₙ₊₁ and supply stop time T2ₙ₊₁ for the (n+1)th deionization step and reclamation step and determines the period Ta using the process described above.

In the case of the first reclamation step, the control section 40 opens and closes the valve V3 at a supply start time T1ₙ and a supply stop time T2ₙ acquired from a separate testing process such as a trial run.

The supply start time T1ₙ and the supply stop time T2ₙ may also be acquired by the following method, using the scale component concentration acquired in the (n−1)th step.

In the (n−1)th deionization step and reclamation step, the control section 40 acquires the scale component concentrations C1 and C2 at the respective times t1ₙ₋₁−tr and t2ₙ₋₁−tr.

In the nth deionization step and reclamation step, the control section 40 acquires the time at which the scale component concentration reached C1 as the supply start time T1ₙ. The valve V3 is opened at the acquired supply start time T1ₙ. In a similar manner, the time at which the scale component concentration reached C2 is acquired as the supply stop time T2ₙ. The control section 40 closes the valve V3 at the acquired supply stop time T2ₙ.

When performing preliminary testing or test operation, the time variation in the concentration of the scale component ions is acquired in advance by the measurement section 30 during preliminary testing, test operation, or adjustment operation.

The timing of the deionization steps and reclamation steps is set in advance. Accordingly, the times at which the deionization steps and reclamation steps take place are correlated with the time variation of the scale component ion concentration. Based on the variation in ion concentration acquired in advance, the scale component concentration is acquired, and the supply start time T1ₙ and supply stop time T2ₙ for the nth deionization step and reclamation step are then acquired, using the same technique as the supply step described above.

As described above, because the deionization step and the reclamation step are repeated in a cycle lasting from several minutes to several tens of minutes, the water quality of the water to be treated changes gradually between the (n−1)th step and the nth step. If the scale component concentration measured by the measurement section 30 does not reach the threshold A in the (n−1)th deionization step and reclamation step, then the control section 40 does not acquire the supply start time T1ₙ and the supply stop time T2ₙ. In this case, the valve V3 is not opened in the nth deionization step and reclamation step.

If the tank 21 of the supply section 20 contains a low ion concentration water, opening and closing the valve V3 causes a predetermined quantity of the low ion concentration water to be supplied to the deionization section 10 during the period Ta. This reduces the ion concentration in the water flowing through the inter-electrode flow channel 15, and causes the concentration of the scale component to fall below the saturation concentration, thus preventing the formation of scale. The control section 40 may introduce only the low ion concentration water into the deionization section 10 during the period Ta, or provided that the scale component concentration can be kept below the saturation concentration, may introduce a mixture of the low ion concentration water and the water to be treated.

The flow rate of the low ion concentration water supplied in accordance with the scale component concentration may also be controlled using the threshold A. In this case, the valve V3 is a valve for which the degree of opening can be adjusted.

When the valve V3 is open and the low ion concentration water is being supplied in the (n−1)th deionization step and reclamation step, the measurement section 30 monitors the concentration of the scale component ions. If the scale component concentration acquired from the scale component ion concentration measured by the measurement section 30 equals or exceeds the threshold A, the control section 40 increases the degree of opening of the valve V3 in the supply step in the nth deionization step and reclamation step, thereby increasing the flow rate of the low ion concentration water.

The control section 40 may also supply the low ion concentration water intermittently in the supply step. In this case, the time interval at which the opening and closing of the valve V3 is repeated during the period Ta is input in advance to the memory of the control section 40, and the control section 40 opens and closes the valve V3 at this time interval in the nth deionization step and reclamation step. This time interval is set appropriately based on the variation in scale component concentration of the deionization section 10 acquired during a test operation or the like.

Alternatively, if, during the (n−1)th deionization step and reclamation step, the scale component concentration in the deionization section 10 varies between values on both sides of the threshold A, then the control section 40 acquires a plurality of supply start times T1ₙ and supply stop times T2ₙ. In other words, a plurality of periods Ta are acquired in the nth deionization step and reclamation step. Moreover, in the nth deionization step and reclamation step, the valve V3 is opened and closed at each of the supply start times T1ₙ and supply stop times T2ₙ, thereby supplying the low ion concentration water intermittently to the deionization section 10.

In the control method described above, the control section may control the flow rate of the low ion concentration water using the threshold A′ (from 0.5 times to less than 1 times the threshold A). In this case, the scale component concentration of the deionization section can be reliably prevented from exceeding the saturation concentration.

If the tank 21 contains a scale inhibitor, then in the period Ta, the control section 40 supplies a predetermined amount of the scale inhibitor to the water to be treated or the low ion concentration water. The scale inhibitor is transported into the deionization section 10 by the flow of the water to be treated or the low ion concentration water, thereby supplying the scale inhibitor to the deionization section 10. The presence of the scale inhibitor means that even if the saturation concentration of the scale component is exceeded, the concentration remains below the precipitation limit, enabling the production of scale to be prevented.

To obtain the effects of the scale inhibitor, the scale inhibitor should be transported into the deionization section 10 in the period Ta. Accordingly, the flow rate of the water to be treated during the supply step may be lower than the flow rate of the water to be treated in the deionization step. The water to be treated may be supplied continuously, or may be supplied intermittently.

Transporting the scale inhibitor using the low ion concentration water means providing two supply sections 20. In this case, the supply section 20 which stores the low ion concentration water is preferably installed on the upstream side from the supply section 20 which stores the scale inhibitor.

In this manner, when supplying the scale inhibitor and the low ion concentration water during the supply step, the control section 40 may simultaneously perform opening and closing of the valves V3 of the two supply sections 20 at the supply start time T1ₙ and supply stop time T2ₙ described above. In other words, the control section 40 supplies the scale inhibitor and the low ion concentration water to the deionization section 10 with the same timing.

Alternatively, the control section 40 can offset the supply start time of the scale inhibitor and the supply start time of the low ion concentration water.

When supplying the scale inhibitor first, the control section 40 opens and closes the valve V3 of the supply section 20 which stores the scale inhibitor at the supply start time T1ₙ and supply stop time T2ₙ acquired in the manner described above. In the (n−1)th deionization step and reclamation step, if the scale component concentration in the deionization section 10 exceeds a value (deemed threshold A″) at which there is a possibility that scale production may occur despite supplying the scale inhibitor, then the control section 40 uses the threshold A″ to acquire a supply start time T1ₙ″ and a supply stop time T2ₙ″ for a valve V3′ of the supply section 20′ which stores the low ion concentration water. Moreover, the control section 40 supplies the low ion concentration water to the deionization section 10 by opening and closing the valve V3′ at the supply start time T1ₙ″ and the supply stop time T2ₙ″ in the nth deionization step and reclamation step.

When supplying the low ion concentration water first, the control section 40 opens and closes the valve V3 at the supply start time T1ₙ and the supply stop time T2ₙ acquired in a similar manner to that described above for the supply section 20′. If the scale component concentration in the deionization section 10 reaches the threshold A in the (n−1)th deionization step and reclamation step despite supplying the low ion concentration water, then the control section 40 acquires the supply start time T1ₙ″ and supply stop time T2ₙ″ for the valve V3 of the supply section 20 which stores the scale inhibitor. The control section 40 supplies the scale inhibitor to the deionization section 10 by opening and closing the valve V3 at the supply start time T1ₙ″ and supply stop time T2ₙ″ in the nth deionization step and reclamation step.

When supplying both the scale inhibitor and the low ion concentration water, the control section 40 can adjust the supplied amount of low ion concentration water in a similar manner to that described above, or intermittently supply the low ion concentration water.

Next is a description of the supply step in the case when the scale inhibitor or the low ion concentration water is supplied while the deionization section 10 is stopped.

If the amount of water to be treated supplied to the deionization section 10 is below a prescribed value, or the amount of treated water has reached a prescribed value, then the control section 40 stops the deionization section 10 and the pump (not shown) that supplies the water to be treated to the deionization section 10. If a plurality of deionization sections 10 are arranged in parallel, then a state is obtained is which one of the deionization sections 10 stops while the deionization step and reclamation step continue in the other deionization sections 10.

When the deionization section 10 is in a stopped state, the control section 40 closes the valve V1 and opens the valve V2. If the deionization section 10 stops during reclamation, the valve V1 remains closed and the valve V2 remains open.

Suppose the deionization section 10 is stopped at a time T_{Sn} during the nth deionization step and reclamation step.

If T_{Sn} is during the period Ta, then the deionization section 10 stops with the valve V2 in an open state. The control section 40 keeps the valve V3 open, and continues supplying the scale inhibitor and/or the low ion concentration water.

The control section 40 acquires the concentration of the scale component in the (n−1)th deionization step and reclamation step. To acquire this scale component concentration, ion concentration values measured by the measurement section 30 during operation may be used, or the results of preliminary testing or the like may be used. Based on the concentration of the scale component in the (n−1)th deionization step and reclamation step, the control section 40 acquires and stores in memory the time at which the scale component concentration in the deionization section 10 reached the threshold A′ as the supply stop time T2ₙ, in the same manner as that described above in the supply step during operation. At the acquired supply stop time T2ₙ, the valve V3 is closed.

If T_{Sn} is not during the period Ta, the valve V3 is in a closed state when the deionization section 10 stops. If the scale component concentration of the inter-electrode flow channel 15 of the deionization section 10 is high when the deionization section 10 stops, a state in which the inter-electrode flow channel 15 has a high scale component concentration is retained for a long time, creating an environment in which scale can easily precipitate.

The measurement section 30 measures the scale component ion concentration starting from the time Tsn, and sends the measurements to the control section 40. The control section 40 acquires the scale component concentration from the scale component ion concentration at a time T after the time TSₙ, and compares the scale component concentration with the threshold A. If the control section 40 determines that the scale component concentration at a time T has reached the threshold A, then the control section 40 opens the valve V3 and supplies the scale inhibitor and/or the low ion concentration water from the supply section 20. If the scale component concentration measured by the measurement section 30 reaches the threshold A′ after opening the valve V3, the valve V3 is closed. By performing control in this manner, scale precipitation can be prevented even if the concentration of the scale component in the deionization section 10 rises after the deionization section 10 has stopped.

When performing preliminary testing, or a test operation or adjustment operation, the time variation of the concentration of the scale component ions, and the fluctuation over time in the scale component ions after stopping the deionization section, are acquired in advance through measurement by the measurement section 30. The control section 40 acquires the scale component concentration at the time when the deionization section 10 is stopped from the time variation mentioned above. Based on the acquired scale component concentration and the fluctuation over time mentioned above, the control section 40 estimates the scale component concentration in the deionization section after the deionization section has stopped. If the estimated scale component concentration is predicted to reach the threshold A, then the control section 40 opens the valve V3 and the scale inhibitor and/or the low ion concentration water is supplied from the supply section 20. Furthermore, if the concentration is predicted to reach the threshold A′, then the control section 40 closes the valve V3, and the supply of scale inhibitor and/or the low ion concentration water from the supply section 20 is stopped.

In this manner, by employing the present embodiment, the scale inhibitor and/or the low ion concentration water can be supplied for a time period tailored to the scale component concentration in the deionization section 10, in the deionization step, in the reclamation step, or while the deionization section is stopped.

If the deionization step and the reclamation step are performed repeatedly, the deionization performance decreases as a result of phenomena as the ions adsorbed to the electrodes 11 and 13 not sufficiently desorbing in the reclamation step, precipitation of the scale component, and the accumulation of solid matter. Thus, maintenance of the deionization treatment device 4 such as electrode replacement is performed regularly. Maintenance is performed when the ion concentration measured by the measurement section 30 in the deionization step has exceeded a predetermined value, or after a predetermined operating time (for example, one month). In the case where maintenance schedules are managed based on operating times, the operating time is preferably set in accordance with the ion concentration measured by the measurement section 30 in the deionization step.

### Second Embodiment

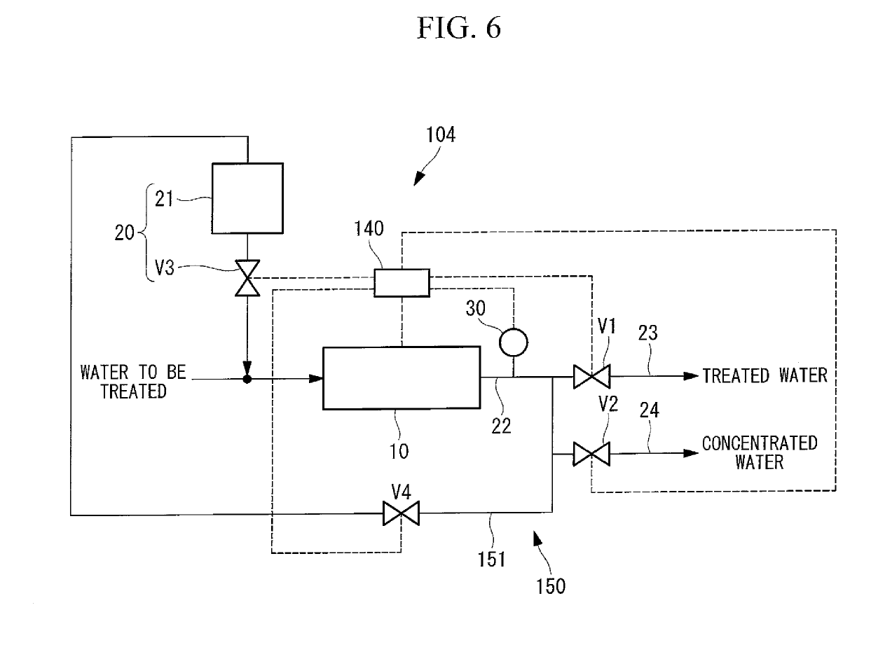

FIG. 6 is a schematic diagram of a deionization treatment device according to a second embodiment. In FIG. 6, structural elements that are the same as in FIG. 3 are assigned the same reference signs. The deionization treatment device of the second embodiment can also form part of the water reclamation system 1 illustrated in FIG. 1.

In a deionization treatment device 104 of the second embodiment, a circulation section 150 is provided. The circulation section 150 comprises piping 151 which connects the discharge channel 22 with the tank 21 of the supply section 20, and a valve V4 located between the discharge channel 22 and the tank 21. The valve V4 is connected to a control section 140.

In the second embodiment, as with the first embodiment, the measurement section 30 need not necessarily be permanently installed in the deionization treatment device 104.

In the second embodiment, the control section 140 stores a scale component concentration threshold B. The threshold B can be set to an appropriate value with due consideration of the water quality of the water to be treated. For example, the threshold B can be set to a value less than 1 times the saturation concentration value of the scale component, and preferably within a range of 0.1 to 0.5 times the saturation concentration value.

A water reclamation method using the deionization treatment device 104 of the second embodiment is described below, using an example in which the measurement section 30 is permanently installed in the deionization treatment device 104.

The control section 140 opens the valve V4 at the same time as the start of the reclamation step (closing of the valve V1). However, in the second embodiment, the valve V2 is not opened at the same time as the start of the reclamation step. Consequently, the concentrated water travels from the discharge channel 22 through the circulation section 150 and is stored in the tank 21.

At a time T3 when the scale component concentration acquired from the ions measured by the measurement section 30 has reached the threshold B, the control section 140 closes the valve V4 and opens the valve V2. This stops storage of the concentrated water.

The step described above may be performed based on the time variation of the concentration of scale component ions acquired by the measurement section 30 during preliminary testing, test operation, or adjustment operation. In this case, the time variation of the scale component concentration is acquired from the ion concentration time variation acquired in advance, and the time T4 at which the scale component concentration reaches the threshold B is determined. During actual water treatment operation, the control section performs storage of the concentrated water in the interval from the start of reclamation to the time T4.

In the present embodiment, the concentrated water having a low scale component concentration stored in the tank 21 is supplied to the deionization section 10 as the low ion concentration water. The supply method is the same as in the first embodiment. The residual scale component concentration in the deionization section 10 is low at the beginning and end of the reclamation step. For this reason, there is no concern that circulating the concentrated water discharged at the beginning and end of the reclamation step in the deionization section 10 may cause the scale component concentration to exceed the threshold A and produce scale.

By employing this type of configuration, a portion of the concentrated water can be used, eliminating the need to supply fresh water from outside as the low ion concentration water, and allowing the water reclamation to be performed more efficiently.

### Third Embodiment

The third embodiment has a configuration in which a portion of the treated water is circulated and used as the low ion concentration water in the deionization treatment device 104.

The control section 140 opens the valve V4 at the same time as closing the valve V1 in the deionization step described in the first embodiment. This causes the treated water to be supplied from the discharge channel 22 to the tank 21 via the circulation section 150, thus starting storage of the treated water. After a predetermined time has elapsed or when the treated water in the tank 21 has reached a prescribed volume, the control section 140 closes the valve V4 and opens the valve V1. This stops storage of the treated water.

In a similar process to that described in the first embodiment, the control section 140 supplies the treated water stored in the tank 21 to the deionization section 10 as the low ion concentration water. In the present embodiment, by controlling the flow rate of the treated water used as the low ion concentration water in accordance with the scale component concentration in the deionization section 10, the amount of treated water that must be circulated can be reduced. As a result, the amount of water supplied from outside can be reduced without greatly reducing the recovery ratio.

The control section 140 may also employ the steps described in the second and third embodiments to store the treated water and the concentrated water having a low scale component ion concentration in the tank 21, and then supply a mixture of the treated water and the concentrated water having a low scale component ion concentration as low ion concentration water.

### Fourth Embodiment

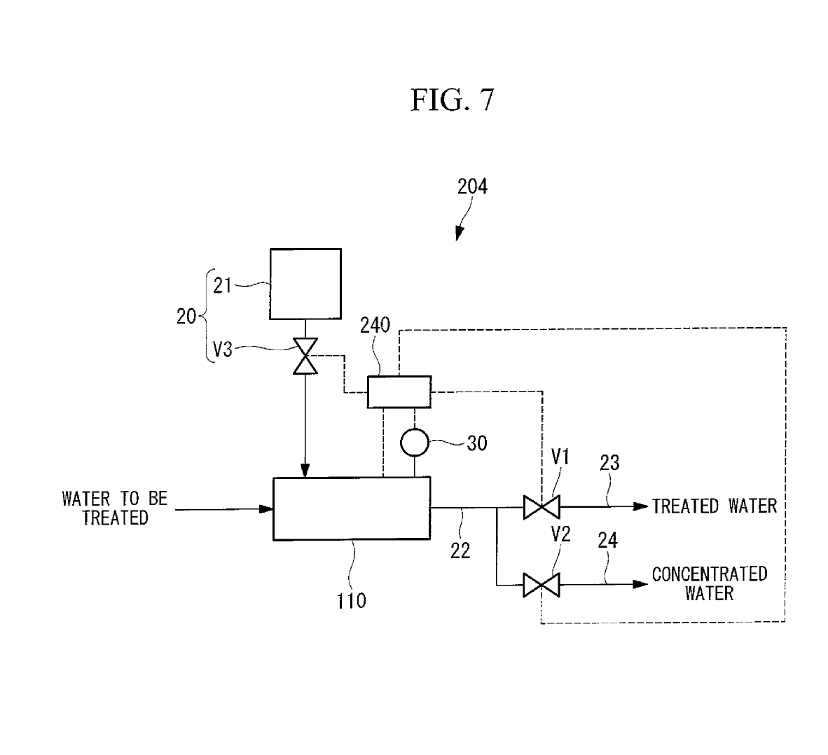

FIG. 7 is a schematic diagram of a deionization treatment device according to a fourth embodiment. In FIG. 7, structural elements that are the same as in FIG. 3 are assigned the same reference signs. The deionization treatment device of the fourth embodiment can also form part of the water reclamation system 1 illustrated in FIG. 1.

In a deionization treatment device 204 in FIG. 7, the measurement section 30 and the supply section 20 are connected to a deionization section 110. The supply section 20 is configured to be able to supply the scale inhibitor and/or the low ion concentration water to the water to be treated flowing through in the inter-electrode flow channel. When both the scale inhibitor and the low ion concentration water are to be supplied to the deionization section 110, two supply sections 20 are connected to the deionization section 110. In the fourth embodiment, as was the case with the previous embodiments, the measurement section 30 need not necessarily be permanently installed in the deionization treatment device 204.

In the deionization treatment device 204 of the fourth embodiment, the actual scale component ion concentration of the water to be treated flowing through the deionization section 110 is detected. In other words, unlike the first embodiment, there is no measurement delay equivalent to the water retention time.

Accordingly, in a water reclamation method using the deionization treatment device 204 of the fourth embodiment, the control section 240 acquires a time t1ₙ₋₁ acquired in the (n−1)th deionization step and reclamation step as a supply start time T1ₙ at which V3 is opened in the nth deionization step and reclamation step. In a similar manner, the control section 240 acquires a time t2ₙ₋₁ acquired in the (n−1)th deionization step and reclamation step as a supply stop time T2ₙ at which V3 is closed in the nth deionization step and reclamation step. The control section 240 assigns the interval between T1ₙ and T2ₙ as the period Ta in which the scale inhibitor and/or the low ion concentration water is supplied. The control section 240 supplies a predetermined amount of the scale inhibitor and/or the low ion concentration water to the supply section 20 during the period Ta in the deionization step and reclamation step.

In the fourth embodiment, the supply step is performed in a similar manner to the first embodiment with the exception of the procedure for determining the period Ta described above. The determination of Ta in the fourth embodiment may be performed using the concentration of scale component ions measured by the measurement section 30 while performing treatment. Alternatively, the scale component concentration may be obtained from the concentration of scale component ions measured in advance during preliminary testing, test operation or adjustment operation, and then used to acquire the timing with which to supply the scale inhibitor and/or the low ion concentration water, with the supply of the scale inhibitor and/or the low ion concentration water during actual water treatment operation then performed in accordance with the acquired timing.

In the deionization treatment device 204 in FIG. 7, a circulation section may be provided in a similar manner to FIG. 6, allowing concentrated water with a low scale component concentration or a portion of the treated water to be reused as the low ion concentration water.

1. A water reclamation system, comprising:
a deionization section which comprises a pair of opposing electrodes that are charged with opposite polarities, an inter-electrode flow channel positioned between the electrodes and through which a water to be treated containing ions can flow, and ion exchange membranes disposed on the inter-electrode flow channel side of each of the electrodes, the deionization section performing a deionization treatment in which the ions are adsorbed to the electrodes and a reclamation treatment in which the ions are desorbed from the electrodes,
a treated water discharge channel which is positioned downstream from the deionization section and discharges, from the deionization section, a treated water from which the ions have been removed during the deionization treatment,
a concentrated water discharge channel which is positioned downstream from the deionization section and discharges, from the deionization section, a concentrated water which contains the ions desorbed from the electrodes during the reclamation treatment,
a supply section which supplies, to the deionization section, at least one of a scale inhibitor and a low ion concentration water which has a lower concentration than the concentrated water of scale component ions, which are the ions that form a scale component, and
a control section which, based on a concentration of the scale component in the deionization section, acquires a supply start time at which the supply section supplies, to the deionization section, at least one of the scale inhibitor and the low ion concentration water, and a supply stop time at which the supply section stops supply of at least one of the scale inhibitor and the low ion concentration water, and which causes the supply section to supply at least one of the scale inhibitor and the low ion concentration water in an interval between the supply start time and the supply stop time.

2. A water reclamation system according to claim 1, wherein
the supply section is installed upstream from the deionization section, and
the control section acquires the supply start time from a time at which a concentration of the scale component reaches a first threshold, and a retention time which represents a time the water to be treated is retained in the deionization section, and acquires the supply stop time from a time at which a concentration of the scale component reaches a second threshold that is at least 0.5 and not more than 1 times the first threshold, and the retention time.

3. A water reclamation system according to claim 1, wherein
the supply section is connected to the inter-electrode flow channel, and
the control section acquires a time at which a concentration of the scale component reaches a first threshold as the supply start time, and acquires a time at which a concentration of the scale component reaches a second threshold that is at least 0.5 times and not more than 1 times the first threshold as the supply stop time.

4. A water reclamation system according to claim 1, further comprising a circulation section which circulates, to the supply section, at least one of the concentrated water discharged from the deionization section and the treated water, wherein
the control section supplies at least one of the concentrated water having a low concentration of the scale component ions and the treated water as the low ion concentration water to the supply section through the circulation section, and from the supply section to the deionization section.

5. A water reclamation system according to claim 1, wherein the control section controls a flow rate of the low ion concentration water based on a concentration of the scale component in the deionization section.

6. A water reclamation system according to claim 1, wherein
a measurement section which measures a concentration of the scale component ions is provided downstream from the deionization section or is connected to the inter-electrode flow channel,
and
the control section acquires a concentration of the scale component from a concentration of the scale component ions measured by the measurement section, and acquires the supply start time and the supply stop time based on the concentration of the scale component.

7. A deionization treatment device, comprising:
a deionization section which comprises a pair of opposing electrodes that are charged with opposite polarities, an inter-electrode flow channel positioned between the electrodes and through which a water to be treated containing ions can flow, and ion exchange membranes disposed on the inter-electrode flow channel side of each of the electrodes, the deionization section performing a deionization treatment in which the ions are adsorbed to the electrodes and a reclamation treatment in which the ions are desorbed from the electrodes,
a treated water discharge channel which is positioned downstream from the deionization section and discharges, from the deionization section, a treated water from which the ions have been removed during the deionization treatment,
a concentrated water discharge channel which is positioned downstream from the deionization section and discharges, from the deionization section, a concentrated water which contains the ions desorbed from the electrodes during the reclamation treatment,
a supply section which supplies, to the deionization section, at least one of a scale inhibitor and a low ion concentration water which has a lower concentration than the concentrated water of scale component ions, which are the ions that form a scale component, and
a control section which, based on a concentration of the scale component in the deionization section, acquires a supply start time at which the supply section supplies, to the deionization section, at least one of the scale inhibitor and the low ion concentration water, and a supply stop time at which the supply section stops supply of at least one of the scale inhibitor and the low ion concentration water, and which causes the supply section to supply at least one of the scale inhibitor and the low ion concentration water in an interval between the supply start time and the supply stop time.

8. A deionization treatment device according to claim 7, wherein
the supply section is installed upstream from the deionization section, and
the control section acquires the supply start time from a time at which a concentration of the scale component reaches a first threshold, and a retention time which represents a time the water to be treated is retained in the deionization section, and acquires the supply stop time from a time at which a concentration of the scale component reaches a second threshold that is at least 0.5 and not more than 1 times the first threshold, and the retention time.

9. A deionization treatment device according to claim 7, wherein
the supply section is connected to the inter-electrode flow channel, and
the control section acquires a time at which a concentration of the scale component reaches a first threshold as the supply start time, and a time at which a concentration of the scale component reaches a second threshold that is at least 0.5 times and not more than 1 times the first threshold as the supply stop time.

10. A deionization treatment device according to claim 7, further comprising a circulation section which circulates, to the supply section, at least one of the concentrated water discharged from the deionization section and the treated water, wherein
the control section supplies at least one of the concentrated water having a low concentration of the scale component ions and the treated water as the low ion concentration water to the supply section through the circulation section, and from the supply section to the deionization section.

11. A deionization treatment device according to claim 7, wherein the control section controls a flow rate of the low ion concentration water based on a concentration of the scale component in the deionization section.

12. A deionization treatment device according to claim 7, wherein
a measurement section which measures a concentration of the scale component ions is provided downstream from the deionization section or is connected to the inter-electrode flow channel,
the control section acquires a concentration of the scale component from a concentration of the scale component ions measured by the measurement section, and acquires the supply start time and the supply stop time based on the concentration of the scale component.

13. A water reclamation method, performed in a deionization section which comprises a pair of opposing electrodes that are charged with opposite polarities, an inter-electrode flow channel positioned between the electrodes and through which a water to be treated containing ions can flow, and ion exchange membranes disposed on an inter-electrode flow channel side of each of the electrodes, the method comprising:
a deionization step of adsorbing the ions in the water to be treated to the electrodes to produce a treated water,
a reclamation step of desorbing the adsorbed ions from the electrodes and releasing the ions into the inter-electrode flow channel, and discharging a concentrated water containing the desorbed ions from the deionization section, and
a supply step in which at least one of a scale inhibitor and a low ion concentration water which has a lower concentration than the concentrated water of scale component ions which are the ions that form a scale component is supplied to the deionization section, wherein
the supply step comprises:
an acquisition step of acquiring, based on a concentration of the scale component in the deionization section, a supply start time at which supply of at least one of the scale inhibitor and the low ion concentration water is started, and a supply stop time at which supply of at least one of the scale inhibitor and the low ion concentration water is stopped,
a supply start step in which supply of at least one of the scale inhibitor and the low ion concentration water is started at the supply start time, and
a supply stop step, performed following the supply start step, in which supply of at least one of the scale inhibitor and the low ion concentration water is stopped at the supply stop time.

14. A water reclamation method according to claim 13, wherein in the acquisition step, the supply start time is acquired from a time at which a concentration of the scale component reaches a first threshold and a retention time which represents a time the water to be treated is retained in the deionization section, and the supply stop time is acquired from a time at which a concentration of the scale component reaches a second threshold that is at least 0.5 times and not more than 1 times the first threshold, and the retention time.

15. A water reclamation method according to claim 13, wherein in the acquisition step, a time at which a concentration of the scale component in the water to be treated passing through the inter-electrode flow channel reaches a first threshold is acquired as the supply start time, and a time at which a concentration of the scale component in the water to be treated passing through the inter-electrode flow channel reaches a second threshold that is at least 0.5 times and not more than 1 times the first threshold is acquired as the supply stop time.

16. A water reclamation method according to claim 13, wherein in the supply step, at least one of the concentrated water having a low concentration of the scale component ions and the treated water is supplied as the low ion concentration water.

17. A water reclamation method according to claim 13, wherein in the supply step, a flow rate of the low ion concentration water is controlled so that a concentration of the scale component in the deionization section is not more than the first threshold.

18. A water reclamation method according to claim 13, further comprising a measurement step in which a concentration of the scale component ions in the concentrated water is measured after passing through the inter-electrode flow channel, or a concentration of the scale component ions in the treated water is measured while passing through the inter-electrode flow channel, wherein
in the acquisition step, a concentration of the scale component is acquired from a measured concentration of the scale component ions, and the supply start time and supply stop time are acquired based on the concentration of the scale component.
